(19) United States
(12) Patent Application Publication
(10) Pub. No.: US 2018/0254677 A1
(43) Pub. Date: Sep. 6, 2018

(54) PERMANENT MAGNET MOTOR

(71) Applicant: AISIN SEIKI KABUSHIKI KAISHA, Kariya-shi, Aichi (JP)

(72) Inventors: Masako SHIBAMORI, Nagoya-shi, Aichi (JP); Gyoo MA, Chiryu-shi, Aichi (JP); Masafumi SAKUMA, Chiryu-shi, Aichi (JP)

(73) Assignee: AISIN SEIKI KABUSHIKI KAISHA, Kariya-shi, Aichi (JP)

(21) Appl. No.: 15/770,985

(22) PCT Filed: Oct. 19, 2016
(86) PCT No.: PCT/JP2016/080894

§ 371 Date: Apr. 25, 2018

(30) Foreign Application Priority Data
Oct. 29, 2015 (JP) 2015-213295

(51) Int. Cl. H02K 1/27

(52) U.S. Cl. CPC H02K 1/2766; H02K 29/03; H02K 2201/06

(57) ABSTRACT

Reduction in drive torque of a permanent magnet motor having a skew arrangement is to be suppressed. A permanent magnet motor has a rotor including a rotor core formed as a stacked assembly of a plurality of electromagnetic steel sheets stacked one upon another and magnets accommodated within accommodation holes formed inside the rotor core. The rotor core has a skew arrangement including a first core and a second core that are displaced relative to each other in a circumferential direction relative to an axis of the rotor. The accommodation hole of the first core accommodates a first magnet of the magnets. The accommodation hole of the second core accommodates a second magnet of the magnets. The first magnet and the second magnet are opposed to each other via a first gap therebetween in the direction of the axis.

### TECHNICAL FIELD

The present invention relates to a permanent magnet motor.

### RELATED ART

For a motor using a permanent magnet (e.g. an IPM motor), it is known that torque ripple phenomenon occurs at time of rotational driving of the motor due to attractive/repulsive force between a magnet inserted in its rotor and a slot of its stator. As a method of reducing such torque ripple phenomenon, the art has proposed implementing a skew arrangement (to be referred to simply as “skew” hereinafter) in the rotor.

Patent Document 1 discloses an invention in which a gap for preventing magnetic flux short-circuit formed adjacent a permanent magnet embedded in a rotor of a permanent magnetic motor having a skew is caused to extend more inwards than an inner edge of an end face of the permanent magnet and also to extend with increased width in the circumferential direction. The increase of the circumferential width of the gap allows increase of the screw angle when the rotor is divided into a plurality of parts in its axial direction to provide the skew, thus providing the possibility of reducing the number of division of the rotor.

Patent Document 2 discloses a permanent magnet motor configured such that the torque ripple can be reduced through suppression of torque reduction associated with occurrence of short-circuit flux between stages in the multiple-stage rotor skew arrangement. The rotor used in this permanent magnet motor includes a plurality of stages of rotor cores in the axial direction incorporating a plurality of magnetic poles of permanent magnets and respective core rotors in the multiple stages are displaced in the rotational direction from each other, thus forming the skew integrally. Each stage of rotor core includes, between the magnetic poles of the permanent magnets adjacent each other in the circumferential direction, a flux barrier portion for shielding short-circuit magnetic flux between these magnetic poles. The skew angle, between the adjacent stages of core rotors, is set such that the flux barrier portions of the magnetic poles of these adjacent permanent magnets are overlapped at least partially with each other.

### DOCUMENTS OF PRIOR ART

### Patent Documents

Patent Document 1: Japanese Unexamined Patent Application Publication Hei. No. 5-236687

Patent Document 2: Japanese Unexamined Patent Application Publication No. 2014-150626

### SUMMARY

### Problem to be Solved by Invention

Provision of such skew arrangement results in circumferential displacement of the magnets embedded in the rotor, which displacement causes short-circuit of magnetic flux between the displaced poles of the magnets. With occurrence of such short-circuit magnetic flux, there occurs reduction in the amount of magnetic flux that contributes to torque generation, so that the drive torque per se will decrease disadvantageously. In the case of the permanent magnet motor configurations disclosed in Patent Documents 1 and 2, the magnets embedded in the rotor are arranged such that the circumferential direction thereof may coincide with the longitudinal direction of the same. Thus, the amount of magnetic pole displacement due to the presence of skew is rather small, so that the amount of reduction in the drive torque is rather small correspondingly. However, in case the magnets are embedded such that the radial direction coincides with the longitudinal direction, the amount of the displacement of the magnetic poles due to the skew will be larger. So, in this latter case, the proportion of resultant short-circuit magnetic pole would be higher, thus leading to significant reduction in the drive torque.

In this way, there remains room for further improvement for suppression of drive torque reduction for a permanent magnet motor having a skew arrangement.

### Means for Solving Problem

According to one embodiment of a permanent magnet motor relating to the present invention, the permanent magnet motor comprises:

a rotor including a rotor core formed as a stacked assembly of a plurality of electromagnetic steel sheets stacked one upon another and magnets accommodated within accommodation holes formed inside the rotor core;

the rotor core having a skew arrangement including a first core and a second core that are displaced relative to each other in a circumferential direction relative to an axis of the rotor;

the accommodation hole of the first core accommodating a first magnet of the magnets;

the accommodation hole of the second core accommodating a second magnet of the magnets; and

the first magnet and the second magnet being opposed to each other via a first gap therebetween in the direction of the axis.

If the permanent magnet motor is provided with the skew as above, the first magnet and the second magnet have the skew, so that there occurs irreversible flux loss due to magnetic flux caused by displacement of the magnetic pole faces of the first and second magnets. Occurrence of such irreversible flux loss results in reduction in the magnetic flux generated from the first and second magnet, thus reduction in the drive torque generated by the permanent magnet motor. To counter this, if the permanent magnet motor is configured such that the first magnet and the second magnet are disposed in opposition to each other via a first gap therebetween, torque ripple can be reduced thanks to the implementation of the skew and also drive torque reduction can be suppressed through reduction of the irreversible flux loss.

According to one embodiment of the permanent magnet motor, the permanent magnet motor further comprises:

a stator disposed in an outer circumference of the rotor, with forming a second gap coaxial with the axis and in a radial direction;

a minimal inter-pole distance as the shortest distance in the first gap between one of the N pole and the S pole of the first magnet and the other pole of the second magnet being greater than a distance of the second gap.

With the above-described arrangement, much of the magnetic flux generated by the first magnet and the second magnet will flow to the stator via the second gap that has lower magnetic resistance than the first gap, with corresponding decrease in the magnetic flux that flows through the first gap. With this, it becomes possible to allow the magnetic flux generated by the first magnet and the second magnet to flow with “priority” to the stator, so that reduction of drive torque can be suppressed effectively.

According to one embodiment of the permanent magnet motor, the permanent magnet motor further comprises:

a plate-like member inserted in the first gap between the first core and the second core; and

both the first magnet and the second magnet being in contact with the plate-like member.

With the above arrangement, the whole rotor can be integrated for enhanced strength and also the irreversible flux loss can be reduced for suppression of reduction of drive torque.

According to one embodiment of the permanent magnet motor, the plate-like member comprises a non-magnetic body.

If the plate-like member is formed as a non-magnetic body, due to the magnetic resistance of such plate-like member higher than that of a magnet body, the advantageous effect of irreversible flux loss reduction can be obtained only by insertion of this plate-like member between the first magnet and the second magnet.

According to one embodiment of the permanent magnet motor, the plate-like member comprises a magnetic body having a flux barrier at a flux loss portion which is a portion where at least the first magnet and the second magnet are overlapped with each other as seen in the direction of the axis.

If the plate-like member, when provided as a magnetic body, is present between the first magnet and the second magnet, due to the magnetic resistance of such magnetic plate-like member lower than that of a nonmagnetic plate-like member, short-circuit flux between the first magnet and the second magnet will increase, thus tending to invite occurrence of irreversible flux loss. Then, by providing a flux barrier at a portion where the first magnet and the second magnet are overlapped with each other, even when the plate-like member is formed as a magnetic body, no increase of short-circuit flux between the first magnet and the second magnet will occur, so that the advantageous effect of irreversible flux reduction can be obtained.

According to one embodiment of the permanent magnet motor, the plate-like member has a further flux barrier on a radially inner side of the flux loss portion, in addition of the flux barrier provided at the flux loss portion.

With the above-described arrangement, it is possible to reduce not only the flux loss between the first magnet and the second magnet, but also flux loss that may occur between adjacent magnets within the same core. Thus, the magnetic flux generated by the first magnet and the second magnet can flow to the stator, thus suppressing reduction of drive torque.

According to one embodiment of the permanent magnet motor, the plate-like member has a same shape as the rotor core as seen in the direction of the axis; and a displacement angle of the plate-like member in the circumferential direction is smaller than a skew angle which is a displacement angle between the first core and the second core.

With the above-described arrangement, since the plate-like member has a same shape as the rotor core, there is no need to manufacture the plate-like member separately, so that the production cost of the permanent magnet motor can be reduced with reduction in the number of components to be managed. Moreover, the above arrangement further allows prioritized flow of magnetic flux generated by the first magnet and the second magnet with effective reduction of irreversible flux loss, thus suppressing reduction of drive torque. Moreover, since the first magnet and the second magnet, upon their insertion, come into abutment against the plate-like member, positioning of the first magnet and the second magnet in the axial direction can be done easily.

### BRIEF DESCRIPTION OF THE DRAWINGS

FIG. 1 is a plane view showing a configuration of an IPM motor relating to a first embodiment,

FIG. 2 is a partially enlarged perspective view of the IPM motor,

FIG. 3 is a section taken along line in FIG. 2,

FIG. 4 is a section taken along IV-IV line in FIG. 2,

FIG. 5 is a section taken along V-V line in FIG. 3,

FIG. 6 is a graph showing change in flux loss ratio relative to a distance between an upper-stage magnet and a lower-stage magnet along an axial direction,

FIG. 7 is a graph showing change in torque improvement ratio relative to the distance between the upper-stage magnet and the lower-stage magnet along the axial direction,

FIG. 8 is a section showing a position and an arrangement of a first magnetic body in an IPM motor relating to a second embodiment,

FIG. 9 is a section taken along IX-IX line in FIG. 8,

FIG. 10 is a section showing a position and an arrangement of a second magnetic body in an IPM motor relating to a third embodiment,

FIG. 11 is a section showing a position and an arrangement of a third magnetic body in an IPM motor relating to a variation of the third embodiment,

FIG. 12 is a section showing a position and an arrangement of a nonmagnetic body in an IPM motor relating to a fourth embodiment,

FIG. 13 is a graph comparing flux loss ratios of the IPM motors relating to the respective embodiments, and

FIG. 14 is a graph comparing torque improvement ratios of the IPM motors relating to the respective embodiments.

### EMBODIMENTS

Next, embodiments of the present invention will be described in details with reference to the accompanying drawings.

### 1. First Embodiment

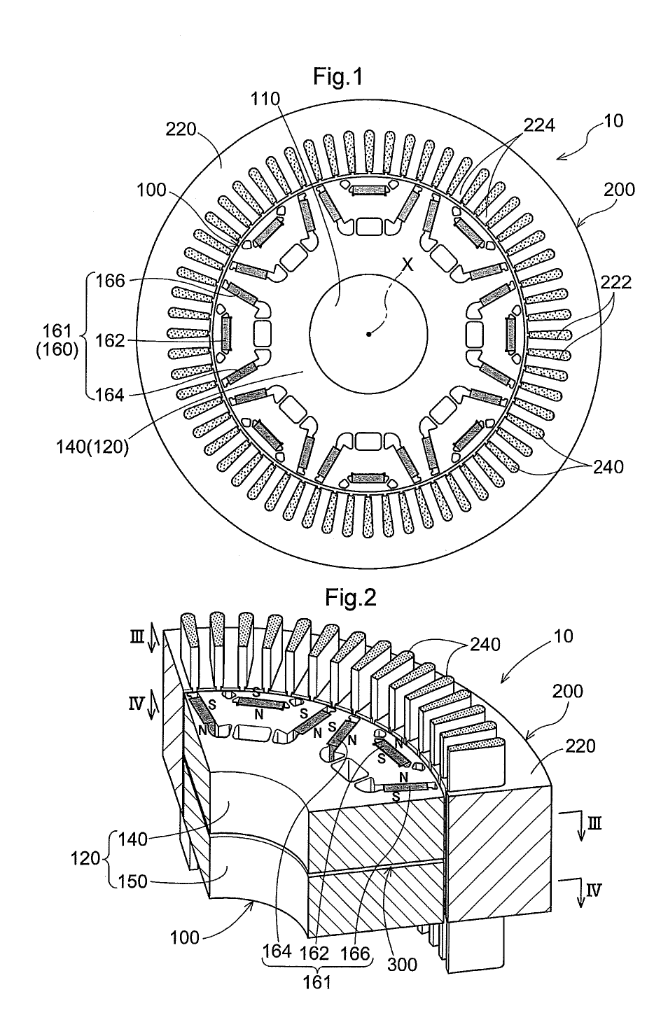

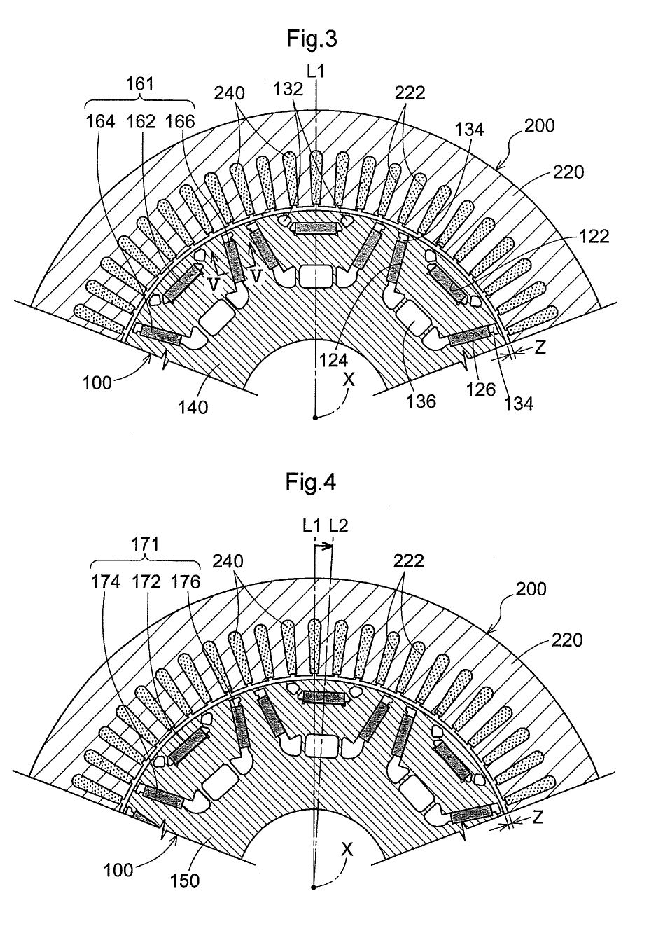

FIG. 1 is a plane view showing a permanent magnet embedded (IMP: interior permanent magnet) motor 10 relating to a first embodiment of the present invention as seen in a direction along a rotational axis of the motor 10. As shown in FIG. 1, the IPM motor 10 includes a rotor 100 and a stator 200 disposed coaxially with and radially outwardly of an axis X of the rotor 100, via a gap Z (see FIG. 3) formed therebetween. Incidentally, the IPM motor 10 is one example of permanent magnet motor and the gap Z is an example of a “second gap” defined herein.

The stator 200 includes a stator core 220 and a coil 240 wound in and around slots 222 of the stator core 220. The stator core 220 comprises a stacked assembly of electromagnetic steel sheets stacked one upon another and has a cylindrical shape as a whole.

The rotor 100 includes the cylindrical rotor core 120 formed by stacking the electromagnetic steel sheets, a shaft 110 inserted and fixed in a through hole formed at the center of the rotor core 120, and rectangular-shaped permanent magnets (may be referred to simply as “magnets” hereinafter) 160 accommodated inside the rotor core 120. Each magnet 160 is magnetized such that its largest face forming the rectangular shape forms magnetic poles (N pole, S pole) (see FIG. 2). In the following, the face having magnetic poles of the faces of the magnet 160 will be referred to as a “magnetic pole face”.

In this embodiment, the number of poles of the rotor 100 is 8 (eight), and for each pole, there are employed 6 (six) magnets 160 (a first upper-stage magnet 162, a second upper-stage magnet 164, a third upper-stage magnet 166, a first lower-stage magnet 172, a second lower-stage magnet 174, a third lower-stage magnet 176). The first upper-stage magnet 162 is fixed in an accommodation hole 122 of the rotor core 120, the second upper-stage magnet 164 is fixed in an accommodation hole 124, the third upper-stage magnet 166 is fixed in an accommodation hole 126 of the same respectively, by such method as adhesive bonding (see FIG. 3). The first lower-stage magnet 172, the second lower-stage magnet 174 and the third lower-stage magnet 176 will be described later.

As shown in FIG. 3, flux barriers 132 are formed in continuation from longitudinal ends of the accommodation hole 122 of the rotor core 120. Further, similarly, flux barriers 134, 136 are formed in continuation from respective longitudinal ends of the accommodation holes 124, 126.

The flux barriers 132 are “gaps” that extend radially outward in continuation from the opposed longitudinal ends of the accommodation hole 122. The entire hole combining the flux barriers 132 and the accommodation hole 122 exhibits a U-shape opening radially outwards. Each flux barrier 132 is divided into two parts by a bridge in order to ensure sufficient strength. However, if the necessary strength can be secured, such bridge need not be provided. The width of the flux barrier 132 as determined in the direction normal to its extending direction is shorter than the width of the shorter side of the first upper-stage magnet 162 in the vicinity of the border with the accommodation hole 122 and this width is equal to the width of the shorter side of the first upper-stage magnet 162 in the other parts thereof.

The flux barriers 134 are gaps that extend radially outwards in continuation from the radially outer ends in the longitudinal direction of the accommodation holes 124, 126 accommodating the second upper-stage magnet 164 and the third upper-stage magnet 166, respectively. The width of the flux barrier 134 as determined in the direction normal to its extending direction is shorter than the width of the shorter side of the second upper-stage magnet 164 or the third upper-stage magnet 166 in the vicinity of the border with the accommodation hole 124, 126 and this width is equal to the width of the shorter side of the second/third upper-stage magnet 164/166 in the other part thereof.

The flux barrier 136 is a gap that extends in the circumferential direction in continuation from the radially inner ends in the longitudinal direction of the accommodation holes 124, 126 accommodating the second upper-stage magnet 164 and the third upper-stage magnet 166, respectively. The flux barrier 136 is disposed on more radially inward than the accommodation holes 124, 126 in such a manner to bridge these accommodation holes 124, 126 to each other. The entire hole combining the flux barriers 134, 136 and the accommodation holes 124, 126 has a U-shape opening radially outwards. The flux barrier 136 is divided into three parts by two bridges for ensuring sufficient strength. However, if the necessary strength can be secured, such bridges need not be provided. The width of the flux barrier 136 as determined in the direction normal to its extending direction is shorter than the width of the shorter side of the second upper-stage magnet 164, the third upper-stage magnet 166 in the vicinity of the border with the accommodation hole 124, 126 and this width is longer than the width of the shorter side of the second upper-stage magnet 164, the third upper-stage magnet 166 in the other parts thereof.

As the rotor core 120 is provided with the flux barriers 132, 134, 136 as described above, short-circuit of magnetic flux between adjacent magnets of the first upper-stage magnet 162, the second upper-stage magnet 164, the third upper-stage magnet 166 is prevented, thus effectively suppressing reduction in the drive torque of the IPM motor 10

The IPM motor 10 is a kind of synchronous motor, configured such that the magnets 160 of the rotor 100 are attracted to a rotational magnetic field generated by application of an alternating electric current to the coil 240 of the stator 200, whereby the rotor 100 is rotated in synchronism with the rotational speed of the rotational magnetic field. In this, the rotational magnetic field will be applied in concentration to teeth 224 disposed between the slots 222 of the stator 200, so that the magnets 160 will be attracted to the teeth 224. Since these teeth 224 are formed in the circumferential direction with equal spacing therebetween, the drive torque generated by the rotor 100 will differ between portions opposed to the teeth 224 and portions not opposed to the same, this difference resulting in the torque ripple phenomenon.

For reducing such torque ripple phenomenon, in this embodiment, the rotor 100 is provided with a skew arrangement (may be referred to simply as “skew” hereinafter). More particularly, as shown in FIGS. 2-4, the rotor core 120 is divided into an upper-stage core 140 and a lower-stage core 150 along the axis X; and relative to the upper-stage core 140, the lower-stage core 150 is displaced clockwise by an angle (angle formed by a line L1 and a line L2 in FIG. 4) along the circumferential direction, which angle corresponds to ½ of the slot 222 of the stator core 220. In the following, this displacement angle between the upper-stage core 140 and the lower-stage core 150 will be referred to as “skew angle”.

With provision of such skew to the rotor core 120, of the magnets 160, there is provided corresponding displacement by the skew angle in the circumferential direction between the upper-stage magnet 161 (generically referring to the first-upper stage magnet 162, the second upper-stage magnet 164, and the third upper-stage magnet 166) accommodated respectively in the accommodation hole 122, 124, 126 of the upper-stage core 140 and the lower-stage magnet 171 (generically referring to the first-lower stage magnet 172, the second lower-stage magnet 174, and the third lower-stage magnet 176) accommodated respectively in the accommodation hole 122, 124, 126 of the lower-stage core 150. The first upper-stage magnet 162 and the first lower-stage magnet 172 have their magnetic pole faces aligned along the circumferential direction, so the displacement amount of the magnetic pole faces thereof due to the skew is rather small. Whereas, the second upper-stage magnet 164 and the second lower-stage magnet 174; and the third upper-stage magnet 166 and the third lower-stage magnet 176, respectively have their magnet pole faces aligned along the radial direction, so the displacement amount of the magnetic pole faces thereof due to the skew is large. In the following description, the term: magnets 160, will be used also to refer generically to the first upper-stage magnet 162, the second upper-stage magnet 164, the third upper-stage magnet 166, the first lower-stage magnet 172, the second lower-stage magnet 174 and the third lower-stage magnet 176 altogether.

With such displacement between magnetic pole faces, when seen in the direction along the axis X, there is formed a magnetic path that short-circuits between one pole (e.g. N pole) of the upper-stage magnet 161 and the other pole (e.g. S pole) of the lower-stage magnet 171. The direction of magnetic flux lines of magnetic flux passing through this magnetic path (may be referred to also as “short-circuit flux 180” hereinafter) is opposite to the direction of magnetic flux that passes the insides of the upper-stage magnet 161 and the lower-stage magnet 171, so that due to this short-circuit magnetic flux 180, there will occur irreversible flux loss (may be referred to simply as “flux loss” hereinafter) in the upper-stage magnet 161, the lower-stage magnet 171. And, with occurrence of such flux loss in the upper-stage magnet 161 and the lower-stage magnet 171, there occurs correspondingly reduction in the magnetic flux generated by the upper-stage magnet 161, the lower-stage magnet 171, which eventually leads to reduction in the drive torque generated by the IPM motor 10.

A flux loss ratio representing a degree (amount) of the flux loss increases with increase of the displacement amount or skew angle of the magnetic pole faces. Namely, the flux loss ratio between the second upper-stage magnet 164 and the second lower-stage magnet 174 and the flux loss ratio between the third upper-stage magnet 166 and the third lower-stage magnet 176 are greater than the flux loss ratio between the first upper-stage magnet 162 and the first lower-stage magnet 172. Further, the shorter the distance along the axial direction between the upper-stage magnet 161 and the lower-stage magnet 171, the greater the flux loss ratio (see FIG. 6).

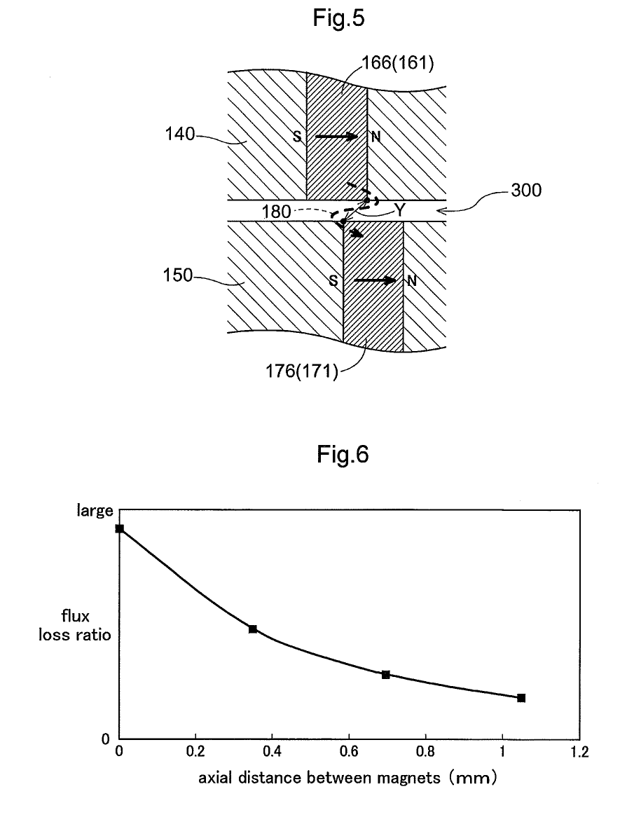

In order to reduce the short-circuit flux 180, the skew angle may be made smaller. This, however, does not make torque ripple phenomenon reduction possible. For this reason, in the instant embodiment, as illustrated in FIG. 5, the upper-stage core 140 and the lower-stage core 150, namely, the upper-stage magnet 161 and the lower-stage magnet 171 having the skew angle therebetween, are separated from each other in the direction along the axis X, thus forming a gap 300 (an air layer) therebetween, as a measure to reduce the short-circuit flux 180. As shown in FIG. 5, the short-circuit flux 180 occurs between the N pole of the third upper-stage magnet 166 and the S pole of the third lower-stage magnet 176 extending in the direction perpendicular to the plane of this drawing. In the following discussion, the shortest distance between the magnetic pole faces causing the short-circuit flux 180 will be referred to as “minimal inter-pole distance” (the distance Y in FIG. 5). And, this minimal inter-pole distance is set to be greater than the distance of the gap Z shown in FIG. 3. Further in this regard, the minimal inter-pole distance between the second upper-stage magnet 164 and the second lower-stage magnet 174 is set equal to the distance Y. Incidentally, the gap 300 is one example of the “first gap” defined herein.

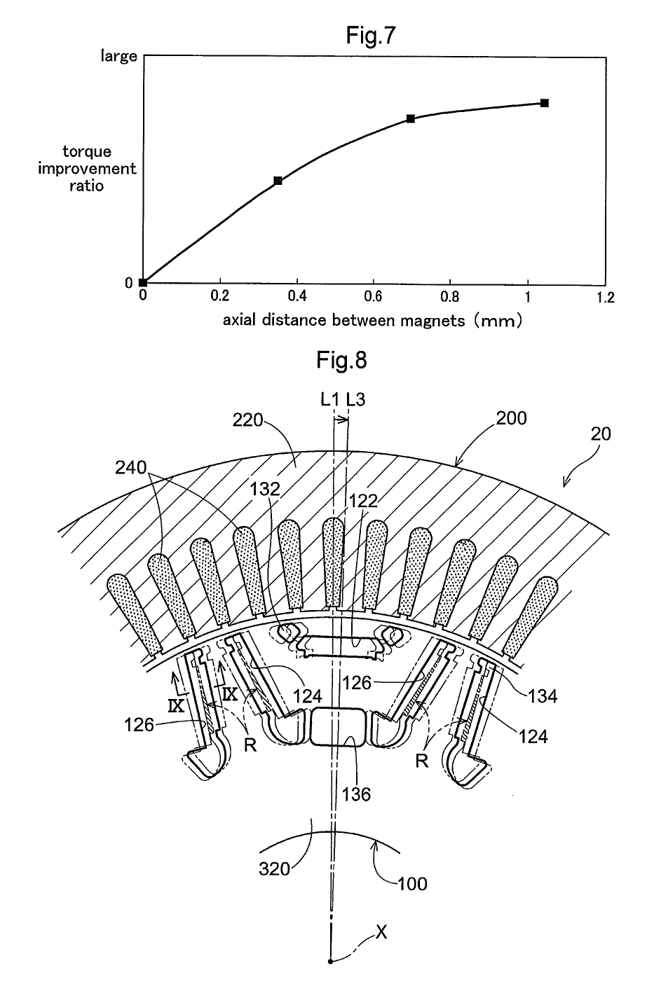

If such gap 300 is present between the upper-stage magnet 161 and the lower-stage magnet 171, the short-circuit flux 180 is caused to pass through the air that has higher magnetic resistance than the rotor core 120 or the magnets 160, whereby the magnetic flux included in the magnetic flux generated by the magnets 160 that becomes the short-circuit flux 180 is reduced, thus increasing, in turn, the magnetic flux contributing to torque generation. As shown in FIG. 6 and FIG. 7, if “axial distance between magnets” which is the size of the gap 300 increases, this results in corresponding decrease in the flux loss ratio and corresponding increase in the torque improvement ratio. Based on this, it may be understood that provision of the gap 300 results in decrease in the short-circuit flux 180. Moreover, since the minimal inter-pole distance (the distance of Y in FIG. 5) is set greater than the gap Z, more of the magnetic flux generated by the upper-stage magnet 161 will flow through the gap Z, i.e. the stator 200, so reduction of drive torque can be effectively suppressed.

In this way, by providing the gap 300, it is possible to suppress flux loss between the upper-stage magnet 161 and the lower-stage magnet 171 while reducing torque ripple by provision of the skew between the upper-stage core 140 and the lower-stage core 150 and also to suppress flux loss between the upper-stage magnet 161 and the lower-stage magnet 171, thus suppressing reduction in the drive torque. Further, as shown in FIG. 2, in the instant embodiment, the total combined axial thickness of the upper-stage core 140, the gap 300 and the lower-stage core 150 is set equal to the thickness of the stator core 220. Namely, under the state including the gap 300, the outer circumferential face of the rotor core 120 as a whole is placed in opposition to the inner circumferential face of the stator core 220.

### 2. Second Embodiment

Next, an IPM motor 20 relating to a second embodiment of the present invention will be described in details with reference to the accompanying drawings. In the following discussion of this embodiment, same portions as those in the first embodiment will be denoted with same or like reference marks/numerals and explanation thereof will be omitted.

The IPM motor 20 differs from the first embodiment in that a first magnetic body 320 is inserted at the portion of the gap 300 included in the IPM motor 10. The rest of its configuration is identical to the first embodiment. The first magnetic body 320 is one example of a “plate-like member” defined herein and the thickness of this first magnetic body 320 is one example of the “first gap” defined herein.

The first magnetic body 320 comprises either a single electromagnetic steel sheet or a stacked assembly of a plurality of such electromagnetic steel sheets constituting the rotor core 120. The first magnetic body 320 is placed in contact with the bottom face of the upper-stage core 140 and the top face of the lower-stage core 150, with no axial gap (air layer) being present between the upper-stage core 140 and the lower-stage core 150. FIG. 8 shows a degree of skew provided for the upper-stage core 140, the lower-stage core 150 and the first magnetic body 320, via the accommodation holes 122, 124, 126 and the flux barriers 132, 134, 136. In FIG. 8, of two U-shaped holes formed of the accommodation holes 122, 124, 126 and the flux barriers 132, 134, 136, the hole shown by the solid line is the first magnetic body 320 and the one shown by two-dot chain line and displaced counterclockwise from the first magnetic body 320 is the upper-stage core 140 and the one displaced clockwise is the lower-stage core 150.

Like the first embodiment, the lower-stage core 150 is displaced clockwise by a skew angle relative to the upper-stage core 140 and the first magnetic body 320 is displaced relative to the upper-stage core 140 by an angle (the angle formed by L1 and L3 in FIG. 8) which is a half of the skew angle, i.e. by an angle corresponding to ¼ slot of the slot 222 of the stator core 222 in the circumferential direction.

As described above, the first magnetic body 320 comprises a stacked assembly of one or plurality of electromagnetic steel sheet(s) constituting the rotor core 120. Therefore, there is no need for manufacturing a special shape as the first magnetic body 320. Consequently, the number of components to be managed can be reduced, thus reducing the production cost of the IPM motor 20. Further, since the first magnetic body 320 is placed in contact with the bottom face of the upper-stage core 140 and the top face of the lower-stage core 150, these altogether are integrated as the rotor core 120. Thus, compared with the rotor core 120 in the first embodiment provided with the gap 300, the strength of the rotor core 120 as a whole can be enhanced.

Although the magnets 160 are not shown in FIG. 8 for better understanding, in actuality, three upper-stage magnets 161 are inserted in the upper-stage core 140 and three lower-stage magnets 171 are inserted in the lower-stage core 150, respectively.

Whereas, no member or component is inserted in the first magnetic body 320. When seen in the direction along the axis X under this condition, the second upper-stage magnet 164 and the third upper-stage magnet 166 accommodated in the upper-stage core 140 and the second lower-stage magnet 174 and the third lower-stage magnet 176 accommodated in the lower-stage core 150 are overlapped with each other, respectively. These overlapped areas R (may be referred to simply as “area R”, hereinafter) are shown with hatching. Incidentally, the overlapped area R is one example of “flux loss portion” defined herein.

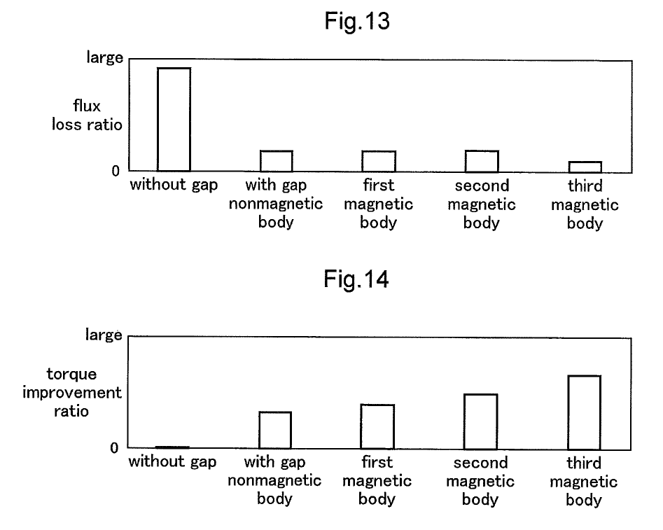

In this area R, there is generated displacement between magnetic pole faces between the upper-stage magnet and the lower-stage magnet, so short-circuit flux 180 is generated, thus causing flux loss. In FIG. 8, this area R is overlapped with the accommodation holes 124, 126 of the first magnetic body 320. Namely, air layers are present in the area R between the second upper-stage magnet 164 and the second lower-stage magnet 174 and in the area R between the third upper-stage magnet 166 and the third lower-stage magnet 176. Therefore, most of the magnetic flux generated by the magnets 160 will not become short-circuit flux 180, but will flow to the stator 200 via the upper-stage core 140, the lower-stage core 150 and the first magnetic body 320 having lower magnetic resistances. Accordingly, with the IPM motor 20 of this embodiment, as shown in FIG. 13 and FIG. 14, in comparison with the arrangement of no gap being present between the upper-stage magnet 161 and the lower-stage magnet 171, the flux loss ratio is significantly reduced and the torque improvement ratio is improved also.

In this way, in the first magnetic body 320, the U-shaped hole consisting of the accommodation hole 122 and the flux barrier 132 as a whole and the U-shaped hole consisting of the accommodation holes 124, 126 and the flux barriers 134,136 as a whole, respectively serve as “flux barrier”.

FIG. 13 is a graph comparing flux loss ratios among the arrangement of omitting the gap between the upper-stage core 140 and the lower-stage core 150 (between the upper-stage magnet 161 and the lower-stage magnet 171), the arrangement of providing the gap 300 (first embodiment), the arrangement of inserting a nonmagnetic body 380 (fourth embodiment to be described later), the arrangement of inserting a first magnetic body 320 (second embodiment) and the arrangement of inserting a third magnetic body 360 (variation of third embodiment to be described later). As shown in FIG. 13, the flux loss ratio is largest when the gap is omitted and this flux loss ratio decreases in the order of the gap 300 plus the non-magnetic body 380, the first magnet body 320, the second magnetic body 340 and the third magnetic body 360.

FIG. 14 is a graph comparing degrees of torque improvement ratios among the arrangement of providing the gap 300 between the upper-stage core 140 and the lower-stage core 150, the arrangement of inserting the non-magnetic body 380, the arrangement of inserting the first magnetic body 320, the arrangement of inserting the second magnetic body 340 and the arrangement of inserting the third magnetic body 360, with assuming the torque improvement ratio being defined zero in the case of omitting the gap. Referring to this FIG. 14, relative to the case of omitting the gap, the torque improvement ratios improve progressively in the order of the gap 300 plus the nonmagnetic body 380, the first magnet body 320, the second magnetic body 340 and the third magnetic body 360. The arrangements of the nonmagnetic body 380, the second magnetic body 340 and the third magnetic body 360, etc. will be detailed later.

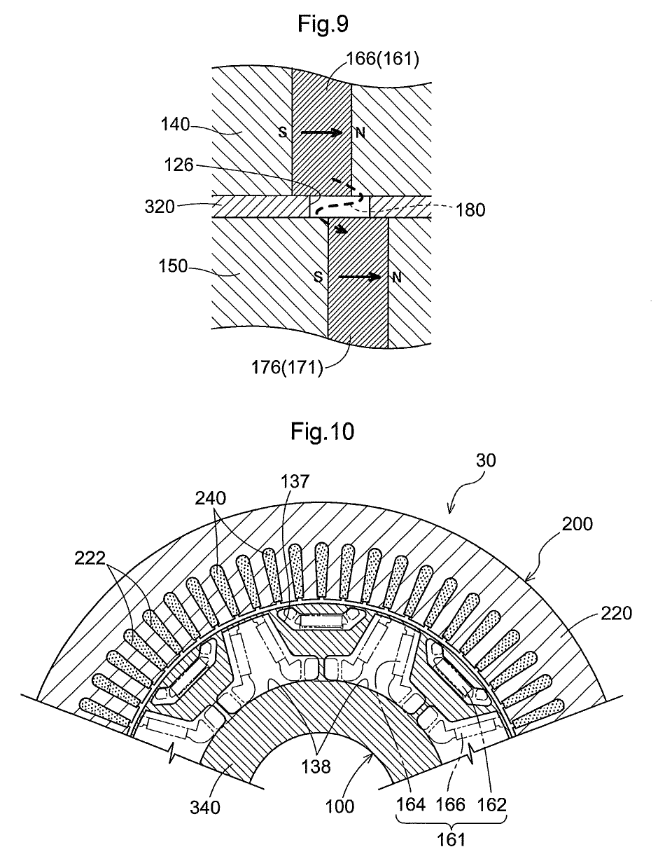

Further, in the instant embodiment, as shown in FIG. 9, when the upper-stage magnet 161 and the lower-stage magnet 171 are inserted into the accommodation holes 122, 124, 126 of the upper-stage core 140 and the lower-stage core 150, respectively, portions thereof come into contact with the first magnetic body 320. With this, the axial positions of the upper-stage magnet 161 and the lower-stage magnet 171 can be easily determined.

In this embodiment too, the total combined thickness along the direction of axis combining the upper-stage core 140, the first magnetic body 320, and the lower-stage core 150 altogether is set equal to the thickness of the stator core 220.

### 3. Third Embodiment

Next, an IMP motor 30 relating to a third embodiment of the present invention will be described in details with reference to the accompanying drawings. In the following discussion of this embodiment, same portions as those in the first embodiment and the second embodiment will be denoted with same or like reference marks/numerals and explanation thereof will be omitted.

The IPM motor 30 differs from the second embodiment in that the second magnetic body 340 is inserted instead of the first magnetic body 320 provided in the IPM motor 20. The rest of its configuration is identical to the second embodiment. The second magnetic body 340 is another example of the “plate-like member” defined herein and the thickness of this second magnetic body 340 is another example of the “first gap” defined herein.

The second magnetic body 340 comprises either a single electromagnetic steel sheet or a stacked assembly of a plurality of such electromagnetic steel sheets. As shown in FIG. 10, in comparison with the first magnetic body 320, the second magnetic body 340 is characterized by a greater area of flux barrier. More particularly, a flux barrier 137 of the second magnetic body 340 has a U-shaped hole which is slightly larger than the hole formed by continuous joining between the accommodation hole 122 and the flux barrier 132 provided in the first magnetic body 320. The flux barrier 137 has a constant width in the direction normal to its extending direction. Further, the second magnetic body 340 includes a flux barrier 138 as a hole formed by continuous joining of the adjacent pole accommodation holes 124, 126, the flux barriers 134, 136 provided in the first magnetic body 320 altogether.

As a result, when the IPM motor 30 is seen along the axis X direction, the first upper-stage magnet 162 and the first lower-stage magnet 172 are disposed within the flux barrier 137, whereas the second upper-stage magnet 164, the third upper-stage magnet 166, the second lower-stage magnet 174 and the third lower-stage magnet 176 all are disposed within the flux barrier 138.

In this embodiment too, the upper-stage core 140 and the lower-stage core 150 are displaced clockwise by a skew angle from each other, so short-circuit flux 180 is generated to result in flux loss. However, with the provision of the flux barrier 138, an air layer is present between the second upper-stage magnet 164 and the second lower-stage magnet 174 and between the third upper-stage magnet 166 and the third lower-stage magnet 176, respectively. Thus, most of magnetic flux generated by the magnets will not become short-circuit flux 180, but will flow to the stator 200 via the upper-stage core 140, the lower-stage core 150 and the second magnetic body 340 which respectively have lower magnetic resistances. Accordingly, with the IPM motor 30 of this embodiment, as shown in FIG. 13, the flux loss ratio thereof is significantly improved as compared with the arrangement of providing no gap between the upper-stage magnet 161 and the lower-stage magnet 171 and this flux loss ratio is about same as that of the second embodiment (first magnetic body 320). Further, as shown in FIG. 14, its torque improvement ratio is further increased over the second embodiment.

In this embodiment, the total combined axial thickness of the upper-stage core 140, the second magnetic body 340 and the lower-stage core 150 is set equal to the thickness of the stator core 220.

### 4. Variation of Third Embodiment

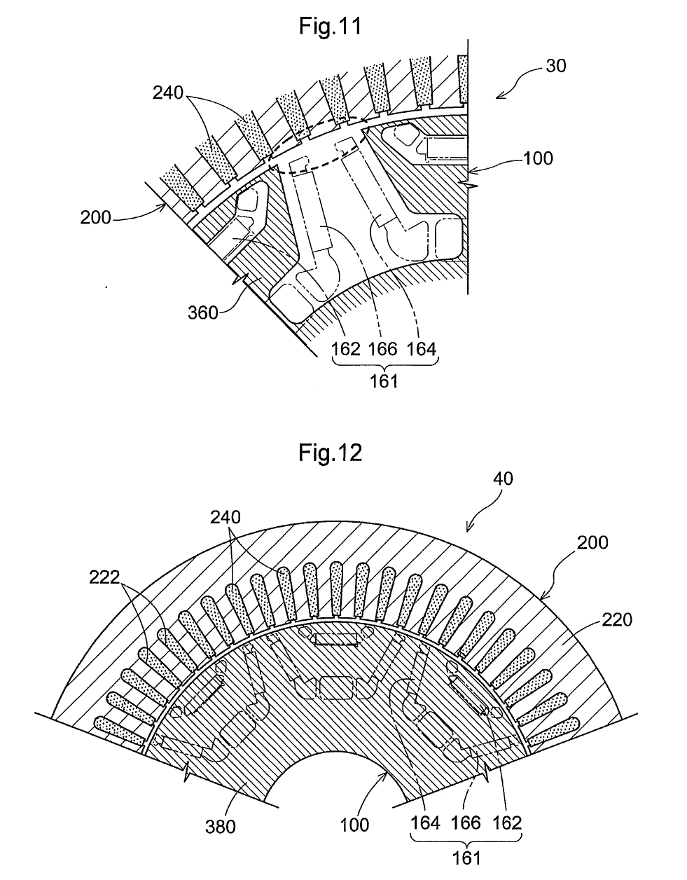

An IPM motor 30 relating to a variation of the third embodiment differs from the third embodiment in that there is employed the third magnetic body 360 that omits the arcuate-shaped electromagnetic steel sheet provided in the second magnetic body 340 of the third embodiment which is present at the portion (portion encircled by one-dot chain line in FIG. 11) extending along the circumferential direction on the radially outer-most side. When this third magnetic body 360 is used, most of the magnetic flux generated by the magnets will not become short-circuit flux 180, but will flow to the stator 200 via the upper-stage core 140, the lower-stage core 150 and the third magnetic body 360 having lower magnetic resistances. Moreover, respecting the magnetic flux which flows through the portion where the arcuate electromagnetic plate is present in the third embodiment, this magnetic flux too will flow to the stator 200, thus contributing to the drive torque. Therefore, the IMP motor 30 of this embodiment, as shown in FIG. 13, exhibits even more improvement over the third embodiment in the respect of the flux loss ratio. Further, as shown in FIG. 14, it exhibits even more improvement in the respect of the torque improvement ratio over the third embodiment. Incidentally, the third magnetic body 360 is still another example of the “plate-like member” defined herein and the thickness of this third magnetic body 360 is another example of the “first gap” defined herein.

In the instant embodiment, the total combined axial thickness of the upper-stage core 140, the third magnetic body 360 and the lower-stage core 150 is set equal to the thickness of the stator core 220.

### 5. Fourth Embodiment

Next, an IMP motor 40 relating to a fourth embodiment of the present invention will be described in details with reference to the accompanying drawings. In the following discussion of this embodiment, same portions as those in the first through third embodiments will be denoted with same or like reference marks/numerals and explanation thereof will be omitted.

As shown in FIG. 12, the IPM motor 40 relating to the fourth embodiment differs from the above-described respective embodiments in that a disc-like nonmagnetic body 380 formed of resin or the like is inserted in place of the first magnetic body 320, etc. The rest of its configuration is identical to the foregoing embodiments. The nonmagnetic body 380 has a magnetic resistance which is higher than those of magnetic bodies, and approximately equal to that of air. Thus, there is no need to provide any flux barrier in this nonmagnetic body 380. Incidentally, the nonmagnetic body 380 is still another example of the “plate-like member” defined herein and the thickness of this nonmagnetic body 380 is still another example of the “first gap” defined herein.

When the nonmagnetic body 380 is used, little of the magnetic flux generated by the magnets 160 will become the short-circuit flux 180. Therefore, the IPM motor 40 of this embodiment, as shown in FIG. 13, exhibits significant improvement in the respect of the flux loss ratio, as compared with the arrangement of providing no gap between the upper-stage magnet 161 and the lower-stage magnet 171, which improvement is substantially same as that of the first embodiment (gap 300). And, as shown in FIG. 14, it exhibits also substantially same degree of improvement in the torque improvement ratio, approximately equal to that of the first embodiment, but less than the degrees of improvement provided in the second embodiment and the third embodiment. A possible explanation of this is as follows. Namely, in comparison with the second and third embodiments, although a portion of the magnetic flux generated by the magnets 160 will not become the short-circuit flux 180, it flowed to the nonmagnetic body 380, thus leading to insufficiency of the magnet flux available from the upper-stage core 140 and the lower-stage core 150 to the stator 200.

In the respective embodiments and variation described above, it was explained that the skew angle is an angle that corresponds to ½ slot of the slot 222 of the stator core 220. However, the invention is not limited thereto. An optimal skew angle can be set, according to various specifications of the IPM motor 10, such as the cogging torque, noise, etc., in addition to the torque ripple.

Moreover, in the respective embodiments and variation described above, the number of division of the rotor 100 for the skew was 2 (two). The invention is not limited thereto. The IMP motor can be configured with three or more number of divisions of the rotor 100.

The arrangements of the respective embodiments and variation described above can be combined in any way as long as no contraction occurs.

### INDUSTRIAL APPLICABILITY

The present invention is applicable to a permanent magnet motor.

### DESCRIPTION OF REFERENCE MARKS/NUMERALS

10, 20, 30, 40: IPM motor (permanent magnet motor)
100: rotor
120: rotor core
122, 124, 126: accommodation hole
132, 134, 136, 137, 138: flux barrier
140: upper-stage core (first core)
150: lower-stage core (second core)
160: permanent magnet (magnet)
161: upper-stage magnet (first magnet)
171: lower-stage magnet (second magnet)
200: stator
300: gap (first gap)
320: first magnet body (plate-like member, first gap)
340: second magnetic body (plate-like member, first gap)
360: third magnetic body (plate-like member, first gap)
380: nonmagnetic body (plate-like member, first gap)
R: overlapped area (flux loss portion)
X: axis
Y: minimal inter-pole distance
Z: gap (second gap)

1. A permanent magnet motor comprising:
a rotor including a rotor core formed as a stacked assembly of a plurality of electromagnetic steel sheets stacked one upon another and magnets accommodated within accommodation holes formed inside the rotor core;
the rotor core having a skew arrangement including a first core and a second core that are displaced relative to each other in a circumferential direction relative to an axis of the rotor;
the accommodation hole of the first core accommodating a first magnet of the magnets;
the accommodation hole of the second core accommodating a second magnet of the magnets; and
the first magnet and the second magnet being opposed to each other via a first gap therebetween in the direction of the axis.

2. The permanent magnet motor of claim 1, further comprising:
a stator disposed in an outer circumference of the rotor, with forming a second gap coaxial with the axis and in a radial direction; and
a minimal inter-pole distance as the shortest distance in the first gap between one of the N pole and the S pole of the first magnet and the other pole of the second magnet being greater than a distance of the second gap.

3. The permanent magnet motor of claim 1, further comprising:
a plate-like member inserted in the first gap between the first core and the second core; and
both the first magnet and the second magnet being in contact with the plate-like member.

4. The permanent magnet motor of claim 3, wherein the plate-like member comprises a non-magnetic body.

5. The permanent magnet motor of claim 3, wherein the plate-like member comprises a magnetic body having a flux barrier at a flux loss portion which is a portion where at least the first magnet and the second magnet are overlapped with each other as seen in the direction of the axis.

6. The permanent magnet motor of claim 5, wherein the plate-like member has a further flux barrier on a radially inner side of the flux loss portion, in addition of the flux barrier provided at the flux loss portion.

7. The permanent magnet motor of claim 5, wherein the plate-like member has a same shape as the rotor core as seen in the direction of the axis; and a displacement angle of the plate-like member in the circumferential direction is smaller than a skew angle which is a displacement angle between the first core and the second core.
